(19) United States
(12) Patent Application Publication
(10) Pub. No.: US 2023/0264556 A1
(43) Pub. Date: Aug. 24, 2023

(54) Housing Lower Part of a High-Voltage Storage Device Housing and Series

(71) Applicant: Bayerische Motoren Werke Aktiengesellschaft, Muenchen (DE)

(72) Inventors: Manuel ANASENZL, Mainburg (DE); Ahmed EL-SAWY, Muenchen (DE); Manuel SCHURZ, Landshut (DE); Marcel STERZENBACH, Essenbach (DE)

(21) Appl. No.: 18/012,309

(22) PCT Filed: Jul. 12, 2021
(86) PCT No.: PCT/EP2021/069287

§ 371 Date: Dec. 22, 2022

(30) Foreign Application Priority Data
Aug. 4, 2020 (DE) 10 2020 120 516.3

(51) Int. Cl. B60K 1/04; H01M 50/242; H01M 50/204

(52) U.S. Cl. CPC B60K 1/04; H01M 50/242; H01M 50/204; B60K 2001/0438

(57) ABSTRACT

Please replace the original Abstract with the following new Abstract: A housing lower part of an energy storage device housing includes a tub-like element, which has lateral wall elements which extend along a longitudinal axis. Sill elements are arranged on the outer side of the wall elements and each projects beyond the wall elements along the longitudinal axis by way of a longitudinal section. Transverse elements are arranged on the end side of the tub-like element and extend transversely to the longitudinal axis. The sill elements are fastened to the end side of the transverse elements by way of the longitudinal sections.

### BACKGROUND AND SUMMARY OF THE INVENTION

The present invention relates to a housing lower part of or for an energy storage device housing and to a series of energy storage device housings.

Energy storage device housings of the type under discussion are used, for example, in partly and fully electrified motor vehicles. The batteries or battery modules are installed in such housings. To implement the required ranges, their storage devices are often very large, which is not a problem with regard to economical series production. In this connection, one requirement in particular is placed on ensuring the required gas-tightness of the energy storage device housings and the housing lower parts.

It is therefore an object of the present invention to specify a housing lower part for an energy storage device housing and a series of energy storage device housings which permit efficient production with, at the same time, the attainment of the highest quality requirements.

This object is achieved by a housing lower part by a series according to the claimed invention.

According to embodiments of the invention, a housing lower part of an energy storage device housing or for an energy storage device housing, such as in particular a high-voltage storage device housing, comprises a trough-like element, wherein the trough-like element has lateral wall elements which extend along a longitudinal axis, and wherein sill elements are arranged on or fastened to the outer side of the wall elements, and each project beyond the wall elements along the longitudinal axis by way of a longitudinal section, wherein transverse elements are arranged in each case on the end side of the trough-like element and extend transversely with respect to the longitudinal axis, and wherein the sill elements are fastened to the end side of the transverse elements by way of the longitudinal sections. This configuration advantageously makes it possible to provide a complete housing lower part of an energy storage device housing on the basis of only a few components. The trough-like element has a bottom element, which defines a bottom plane. When the housing lower part is installed, this is oriented substantially parallel to a roadway plane. From this bottom plane, the wall elements extend away substantially perpendicularly (upward in relation to the roadway plane or bottom plane). In combination with the transverse elements respectively arranged at the end sides, the height of which is expediently matched to the height of the wall elements, the result is thus a circumferentially closed arrangement space for the arrangement of, for example, energy storage cells, energy storage modules, etc. When the housing lower part is installed, the aforementioned longitudinal axis extends, for example, along a direction of travel of the respective motor vehicle. In combination with the sill elements, the transverse elements advantageously form a circumferential frame which can advantageously be designed in such a way as to meet any crash requirements. The transverse elements are advantageously designed and formed in such a way as not only to form the frame but also to continue the trough-like element in such a way that a (closed) arrangement space is formed. In this connection, it should be emphasized that, as a result of this configuration, the number of joining points can be reduced to a minimum. In particular, the length of the joining points or sealing points can be reduced by a multiple as compared with known welded constructions. This reduces not only the outlay on production and assembly but also solves the tightness problem mentioned at the beginning, since the housing lower part produced in this way is already largely tight because of its construction. Thus, the trough-like element, comprising the laterally arranged or formed wall elements, is an in particular one-piece element. According to one embodiment, the wall elements are formed by reshaping regions of the bottom element, designed as a sheet metal part according to one embodiment. The longitudinal sections, which project beyond the trough-like element along the longitudinal axis, contribute considerably to the efficient structure of the housing lower part. The transverse elements can advantageously be fastened via the longitudinal sections. The transverse elements are in particular attached to the longitudinal sections at the end sides, which means that a large and wide attachment surface can be achieved. It is particularly advantageous that this attachment is made outside the arrangement space. This permits high degrees of freedom with regard to the joining techniques used, since no gas- tightness is required at this point.

According to a preferred embodiment, the sill elements are connected to the transverse elements in a form-fitting and/or force-fitting manner, in particular screwed and/or riveted. Preferably, fastening sections are formed on the longitudinal sections—and, analogously, on the transverse elements—for example in the form of bores or holes. According to one embodiment, a large number of fastening elements arranged in a distributed manner, such as screws, are arranged in the region of the longitudinal sections. According to one embodiment, three or four M8 screws are used to attach the transverse elements (for each longitudinal section or fastening section). Therefore, the frame formed by the transverse elements and the sill elements achieves very high strength and stiffness or stability.

According to one embodiment, the wall elements are integrally connected to the sill elements, in particular welded. Preferred welding methods are chosen, for example, from fusion welding methods. According to one embodiment, the attachment of the sill elements to the wall element is carried out by way of metal-inert gas welding (MIG welding). The weld seam may be drawn along the longitudinal axis or else formed in a stepped or point-like manner. Alternative welding methods, such as friction stir welding, are likewise conceivable. It has been shown that, as a result of the integral connection by way of welding, even the highest crash requirements can be met.

According to one embodiment, the wall elements have flange sections or form the latter, wherein the flange sections are preferably oriented parallel to the bottom plane and extend along the longitudinal axis, and wherein the sill elements are fastened to the flange sections. Advantageously, as a result the joining point between the sill elements and the trough- like element is displaced away from the arrangement space. Advantageously, the joining point is therefore located outside the arrangement space.

As already mentioned, the longitudinal sections permit the same advantage. As a result of the end-side fastening of the transverse elements by way of the longitudinal sections, the joining points are advantageously displaced away from the arrangement space. Thus, for example, form-fitting and/or force-fitting connections such as screws and/or rivets, etc., can be used, which would otherwise be a problem for reasons of gas-tightness to be achieved.

According to one embodiment, the transverse elements are integrally fastened to the trough-like element. According to a preferred embodiment, friction stir welding is used as a connecting technique. The transverse elements can be arranged on the trough-like element, for example in an overlapping or abutting manner.

According to a particularly preferred embodiment, the transverse elements are fastened to the trough-like element via a fusion welding method, in particular by way of MIG welding. This method can be implemented reliably and cost-effectively. The tightness, in particular gas-tightness at this point or along the weld seam is preferably produced subsequently via a sealing material applied to the connecting or joining point. The application is carried out, for example in the form of a bead, along the weld seam, on one or both sides.

According to a preferred embodiment, the connecting points or joining points or joining regions, where necessary, are sealed off subsequently, a sealing material being used for this purpose. According to a preferred embodiment, the sealing material is selected from one of the following materials: silane-modified polymer, 2K (two-component) polyurea and/or polyvinyl chloride. It has transpired that the aforementioned materials, in particular in conjunction with the application to preferably bare aluminum material, can provide optimum fluid-tightness, in particular gas-tightness. Particularly preferred is the use of a sealing material made of or based on silane-modified polymers or a silane-modified polymer.

According to a preferred embodiment, the transverse elements are formed in such a way that they continue or extend a geometry of the trough-like element. Expediently, the transverse elements each comprise a bottom section, a wall section and, depending on the configuration of the trough-like element, a flange section. Advantageously, this can ensure that a flat or planar joining region is provided between the transverse elements and the trough-like element. In other words, the joining region describes a plane which is perpendicular to a bottom plane of the trough-like element and perpendicular to the longitudinal axis. This simple geometry permits degrees of freedom in relation to the joining technique used and facilitates the subsequent sealing at the joining points, in particular, for example, because of the good accessibility. In addition, the entire housing lower part in the region of the arrangement space has only two, respectively continuous, joining regions or sealing regions.

According to one embodiment, a large number of transverse beams is arranged along the longitudinal axis, oriented transversely thereto. These are used, for example, for stiffening the housing lower part. According to one embodiment, the attachment is carried out by way of integral connecting techniques, in particular by way of adhesive bonding.

According to a particularly preferred embodiment, the transverse elements are cast parts. In particular these are metal cast components, in particular pressure diecast components. According to one preferred embodiment, the transverse elements comprise contact and/or attachment points for structural or chassis components of the respective motor vehicle. These can be produced integrally during the production of the cast parts and/or also introduced subsequently. According to one preferred embodiment, the sill elements are profiled elements, in particular extruded profiles. This configuration is distinguished by its simplicity. According to one embodiment, the transverse elements are also formed as extruded profiles.

Preferred materials for the sill elements and the transverse elements are aluminum materials or aluminum alloys.

According to a preferred embodiment, the trough-like element is an aluminum sheet part, in particular a folded-back aluminum sheet. In particular, A15 or A16 is used as a preferred material. The representation or implementation of the wall elements is carried out by the reshaping, in particular the folding back. According to one embodiment, the trough-like elements comprise geometric features such as beads, edges or the like for stiffening and for increasing the stability. Preferred wall thicknesses lie in a range from about 2 to 4 mm, in particular in a range from 2.5 to 3.5 mm and particularly preferably at 3 or about 3 mm.

According to one embodiment, the energy storage device housing comprises a correspondingly designed cover element, preferably made of aluminum and/or steel and/or plastic, in particular a composite material. The aforementioned arrangement space can be closed by the cover element. According to one embodiment, the cover element is connected to the housing lower part, preferably in a force-fitting and/or form-fitting manner, by way of an inserted or adhesively bonded seal, for example by way of appropriate screw connections. Alternatively, no separate cover is also provided. The cover is then, for example, integrally formed by the vehicle, for example by an appropriately designed floor assembly.

Finally, it should be mentioned that the energy storage device housing is not restricted to the arrangement of electrical energy storage device (cells). The energy storage device housing can also be used for the arrangement of other energy carriers, such as hydrogen. According to one embodiment, the energy storage device can accordingly comprise one or more hydrogen tanks or itself be designed as a hydrogen tank.

The invention is directed further to a series of energy storage device housings, wherein the series comprises a large number of energy storage device housings and wherein each energy storage device housing has a housing lower part according to embodiments of the invention, wherein the sill elements are profiled elements which, to represent energy storage device housings of different sizes, are preferably cut to length, and wherein the transverse elements have the same length. Advantageously, the sill elements are, for example, meter goods, which are shortened to the desired dimension as needed.

Preferably, the transverse elements have the same length. Correspondingly, the housing lower parts or the energy storage device housings have the same width. According to a preferred embodiment, the transverse elements are identical within the series. This applies, for example, to the corresponding front transverse elements in the direction of travel and to the rear transverse elements, viewed in the direction of travel, among one another. According to a further preferred embodiment, the front and rear transverse elements are also each designed identically, which means that the large number of variants can advantageously be reduced still further.

The fact that the transverse elements can comprise different attachment points for the integration of the energy storage device housing into the respective vehicle in a vehicle- specific manner, possibly subsequently, remains unaffected thereby. These are optionally introduced subsequently or already reserved during the production of the transverse elements.

The trough-like element, wherein this is expediently a sheet metal part here, in particular an aluminum sheet part, is advantageously cut to length in a manner corresponding to the length of the sill elements. The construction permits the implementation of energy storage device housings of different sizes with a minimum number of parts, wherein the necessary joining points or joining regions are shaped and positioned in such a way that, in particular, even the highest requirements on gas-tightness can be met and the production steps necessary for this purpose can be implemented efficiently and well.

Energy storage device housings of the type under discussion have a length in a range from 1.5-3.5 m. The transverse elements preferably have a length of 0.8-2.2 m.

The advantages and features mentioned in connection with the housing lower part apply analogously and correspondingly to the series and vice versa.

Further advantages and features can be gathered from the following description of embodiments of housing lower parts with reference to the appended figures.

### BRIEF DESCRIPTION OF THE DRAWINGS

FIG. 1 shows a schematic view of an embodiment of a housing lower part in a top view.

FIG. 2 shows a side view of an embodiment of a housing lower part in a side view.

FIG. 3 shows a detailed view of the housing lower part from FIG. 1.

FIG. 4 shows a schematic view of an embodiment of a transverse element with two detail views.

### DETAILED DESCRIPTION OF THE DRAWINGS

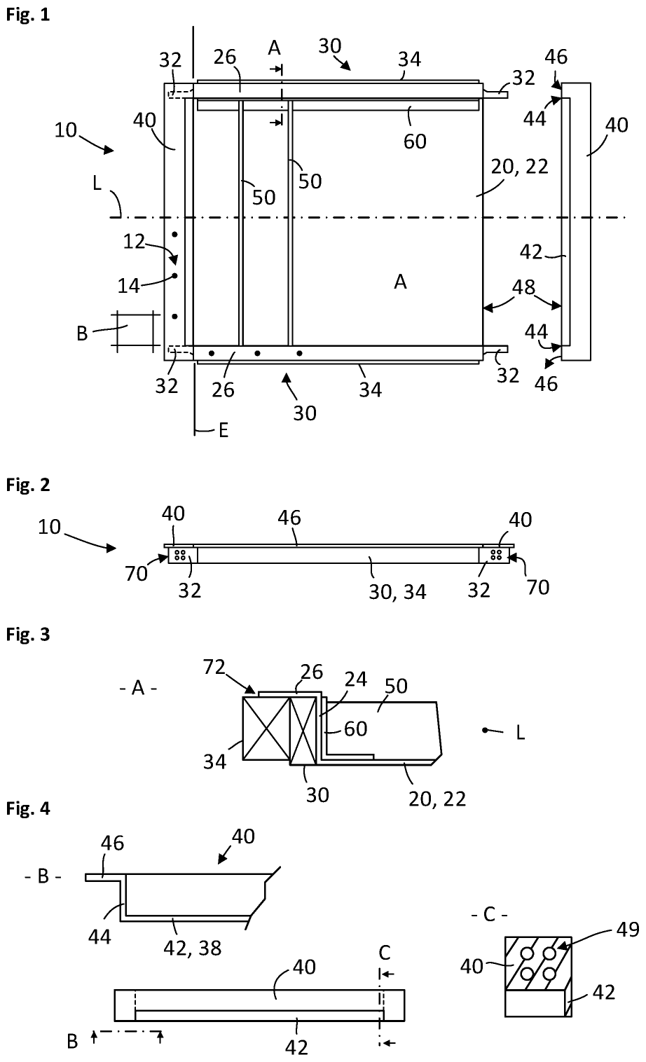

FIG. 1 shows a schematic illustration of a top view of an embodiment of a housing lower part 10. It is possible to see a trough-like element 20, which comprises or forms a bottom element 22. This describes a bottom plane B. When the housing lower part 10 is installed, this is preferably oriented parallel or substantially parallel to a roadway plane. Arranged at the sides on the trough-like element 20 in each case is a sill element 30, wherein this is largely obscured by flange elements 26 of the trough-like element 20. It is possible to see stiffening elements 34 projecting slightly relative to the flange elements 26, which stiffening elements in turn are arranged on the outside of the sill elements 30. These can be profiles or structures which serve to stiffen or reinforce the sill elements 30. The sill elements 30, and also the trough-like element 20, extend along a longitudinal axis L. The sill elements 30 project beyond the trough-like element 20 in each case at the end sides by way of longitudinal sections 32. An arrangement or fastening of transverse elements 40 is made via the latter. The right-hand transverse element 40 is illustrated as spaced apart, that is to say not yet fastened to the trough-like element 20. It is possible to see that the transverse element 40 (cf. in particular the right-hand half of the figure) has a bottom section 42, a wall section 44 and a flange section 46. This geometry is designed to be congruent to a geometry of the trough-like element 20 in the joining region 48. As a result, a joining region 48 can be created which is completely flat or planar, cf. also the designation E. The (sealing) plane E is perpendicular in relation to the longitudinal axis L and the bottom plane B. The transverse elements 40, together with the sill elements 30, form a frame, wherein this frame firstly continues a geometry of the trough-like element 20 and secondly, since the trough-like element 20 is preferably a sheet metal part, guarantees the necessary stiffness and strength and therefore crash-safety of the housing lower part 10. The transverse elements 50, which are oriented transverse to the longitudinal axis L, also contribute thereto. In the present schematic view, only two such transverse elements 50 are illustrated by way of example. It is also illustrated by way of example that the trough-like element 20 can be reinforced by a longitudinal beam 60. It can be seen that the fastening or attachment of the transverse element 40 by the longitudinal sections 32 is carried out outside the arrangement space A. Advantageously, it is consequently possible as a result of this construction to operate with fastening elements such as screws or the like, since the tightness does not have to be provided outside the arrangement space A. On the other hand, the sealing point along the joining region 48, which is located within the arrangement space A, can be sealed off well as a result of its simple geometry. On the frame, formed by the transverse elements 40 and the sill elements 30 and the flange elements 26, which extend along the sill elements 30, a sealing surface 12 is formed, which interacts with a covering element, not shown here, of the energy storage device housing. This covering element is arranged and fixed detachably, for example via fastening points 14, which are illustrated schematically in FIG. 1 as black dots. For reasons of clarity, the fastening points 14 are only partly illustrated.

FIG. 2 shows a schematic illustration of an embodiment of a housing lower part 10 in a side view, it being possible to see a sill element 30 which, at the end sides, in each case forms a longitudinal section 32. Joining points 70 (form-fitting and/or force-fitting) are formed on the longitudinal sections 32 for the arrangement of the transverse elements 40. Designation 46 designates a flange section of the trough-like element 20, which cannot further be seen here.

FIG. 3 shows the section A from FIG. 1. The sill element 30, on the outside of which a stiffening element 34 is arranged, can be seen. The sill element 30 is arranged on the outer side on a wall element 24 of the trough-like element 20. Designation 72 designates an (integral) joining point, for example a welded point, via which the sill element 30 is attached to the trough-like element 20, in the present case indirectly via the stiffening element 34. The flange element 26 brings the advantage that the joining point 72 is positioned away from the arrangement space A, cf. FIG. 1. In the example sketched here, the longitudinal beam 60, which can be used for additional stiffening, is arranged on the inside of the wall element 24. One of the transverse beams 50 can be seen transversely to the longitudinal axis L. The attachment of the transverse beam 50 or of the longitudinal beam 60 is carried out, for example, by way of integral connection technology such as adhesive bonding, in particular, for example, by way of structural bonding.

FIG. 4 shows, in the lower half of the figure (on the left), a schematic view of a transverse element 40, as is basically already known from FIGS. 1 and 2. For improved understanding, two sections or detailed views, cf. B and C, are illustrated enlarged. The detail view B shows the transverse element 40 so to speak from the view of the arrangement space A, cf. FIG. 1, which means that a bottom section 22, a wall section 44 and a flange section 46 can be seen. These form a joining region 48. Expediently, this geometry corresponds to a geometry of the trough-like element, to which the transverse element 40 is connected. In other words, the transverse element 40 continues the geometry of the trough-like element, at least in some regions, as a result of which a joining region 48 which has a particularly simple geometry can be created. The section C shows a schematic view of a configuration of the transverse element 40 in the region of the attachment of the longitudinal sections, cf. for example, FIG. 1. It is possible to see a fastening section 49 which, in the embodiment shown here, has four holes or bores for the arrangement of suitable fastening devices such as screws.

### LIST OF DESIGNATIONS

10 Housing lower part

12 Sealing surface

14 Fastening points of housing upper part

20 Trough-like element

22 Bottom element

24 Wall element

26 Flange element

30 Sill element

32 Longitudinal section

34 Stiffening element

40 Transverse element

42 Bottom section

44 Wall section

46 Flange section

48 Joining region

49 Fastening section

50 Transverse beam

60 Longitudinal beam

70 (Form- and/or force-fitting) joining point

72 (Integral) joining point

L Longitudinal axis

E (Sealing) plane

B Bottom plane

A Arrangement space

1.-13. (canceled)

14. A housing lower part of an energy storage device housing, the housing layer comprising:
a trough-like element, wherein the trough-like element has lateral wall elements which extend along a longitudinal axis,
sill elements that are arranged on an outer side of the wall elements, wherein each of the sill elements projects beyond the wall elements along the longitudinal axis by way of a longitudinal section, and
transverse elements, each of which is arranged on an end side of the trough-like element and extends transversely with respect to the longitudinal axis,
wherein the sill elements are fastened to an end side of the transverse elements by way of the longitudinal sections.

15. The housing lower part according to claim 14,
wherein the sill elements are connected to the transverse elements in at least one of a form-fitting member or a force-fitting manner.

16. The housing lower part according to claim 15, wherein the sill elements are connected to the transverse elements by screws.

17. The housing lower part according to claim 14,
wherein the wall elements are integrally connected to the sill elements.

18. The housing lower part according to claim 17, wherein the wall elements are welded to the sill elements.

19. The housing lower part according to claim 14,
wherein the wall elements have flange sections which are oriented parallel to a bottom element, and the sill elements are fastened to the flange sections.

20. The housing lower part according to claim 14,
wherein the transverse elements are integrally fastened to the trough-like element.

21. The housing lower part according to claim 14,
wherein the transverse elements are formed such that the transverse elements continue a geometry of the trough-like element.

22. The housing lower part according to claim 14,
wherein the transverse elements and the trough-like element are connected via a flat joining region.

23. The housing lower part according to claim 14,
wherein a large number of transverse beams is arranged along the longitudinal axis, and oriented transversely to the longitudinal axis.

24. The housing lower part according to claim 14,
wherein the transverse elements are cast parts.

25. The housing lower part according to claim 14,
wherein the sill elements are profiled elements.

26. The housing lower part according to claim 25,
wherein the sill elements are extruded profiles.

27. The housing lower part according to claim 14,
wherein the trough-like element is a folded-back aluminum sheet.

28. A device comprising:
a series of energy storage device housings,
wherein each energy storage device housing has a housing lower part according to claim 14,
wherein the sill elements are profiled elements which, to represent energy storage device housings of different sizes, are cut to length, and
wherein the transverse elements have a same length.

29. The device according to claim 28,
wherein the transverse elements are identical within the series.
